(19) United States
(12) Patent Application Publication
(10) Pub. No.: US 2014/0071310 A1
(43) Pub. Date: Mar. 13, 2014

(54) IMAGE PROCESSING APPARATUS, METHOD, AND PROGRAM

(71) Applicant: SONY CORPORATION, Tokyo (JP)

(72) Inventor: Hiroshige Kai, Tokyo (JP)

(73) Assignee: SONY CORPORATION, Tokyo (JP)

(21) Appl. No.: 13/975,546

(22) Filed: Aug. 26, 2013

(30) Foreign Application Priority Data
Sep. 10, 2012 (JP) 2012-198544

(51) Int. Cl. H04N 9/73

(52) U.S. Cl. CPC H04N 9/73
USPC 348/223.1

(57) ABSTRACT

There is provided an image processing apparatus including: an eye region detecting unit which detects an eye region of an object in an image; a high luminance pixel detecting unit which detects a high luminance pixel with a higher luminance than a predetermined luminance based on pixels in the eye region detected by the eye region detecting unit; a light source color estimating unit which estimates information of a light source color from the high luminance pixel detected by the high luminance pixel detecting unit; a white balance adjusting amount calculating unit which calculates a white balance adjusting amount based on the information of the light source color estimated by the light source color estimating unit; and an image processing unit which adjusts a white balance of at least a region in the image by using the white balance adjusting amount calculated by the white balance adjusting amount calculating unit.

### BACKGROUND

The present disclosure relates to an image processing apparatus, a method, and a program, and particularly to an image processing apparatus, and a method capable of optimally performing white balance control, and a program.

In the related art, a technology for acquiring a white balance adjusting amount from a white part of the eye of a person has been present. For example, Japanese Unexamined Patent Application Publication No. 2008-182369 discloses a technique, according to which color information of a white part of the eye of a person is detected in a captured image, a white balance adjustment value is computed from the detected color information, and white balance of the captured image is adjusted.

For example, Japanese Unexamined Patent Application Publication No. 2011-109411 discloses a method for determining a white balance correction coefficient of an image based on color information of a plurality of white regions of the eyes when the plurality of white parts of the eyes of persons are detected in a captured image.

### SUMMARY

According to Japanese Unexamined Patent Application Publication Nos. 2008-182369 and 2011-109411 as described above, a white balance correction amount is calculated from color information on white regions of eyes. However, information on the white parts of the eyes significantly varies due to individual differences, hyperemia, and the like and is not accurate enough to calculate a white balance correction amount in many cases.

It is desirable to optimally perform white balance control.

According to an embodiment of the present disclosure, there is provided an image processing apparatus including: an eye region detecting unit which detects an eye region of an object in an image; a high luminance pixel detecting unit which detects a high luminance pixel with a higher luminance than a predetermined luminance based on pixels in the eye region detected by the eye region detecting unit; a light source color estimating unit which estimates information of a light source color from the high luminance pixel detected by the high luminance pixel detecting unit; a white balance adjusting amount calculating unit which calculates a white balance adjusting amount based on the information of the light source color estimated by the light source color estimating unit; and an image processing unit which adjusts a white balance of at least a partial region in the image by using the white balance adjusting amount calculated by the white balance adjusting amount calculating unit.

In this case, the image processing unit may adjust the white balance of a face region of the object in the image, as at least partial region described above, by using the white balance adjusting amount which has been calculated by the white balance adjusting amount calculating unit.

In this case, the image processing unit may adjust the white balance in a region other than the face region of the object in the image based on information of colors of the entire image.

In this case, the image processing unit may adjust the white balance of only the face region of the object in the image by using the white balance adjusting amount which has been calculated by the white balance adjusting amount calculating unit in accordance with a set imaging mode.

In this case, the image processing unit may adjust the white balance of only the face region of the object in the image by using the white balance adjusting amount which has been calculated by the white balance adjusting amount calculating unit in accordance with a brightness level of the image.

In this case, the white balance adjusting amount calculating unit may calculate the white balance adjusting amount based on the information of the colors of the entire image when the eye region detecting unit has not detected the eye region of the object or the high luminance pixel detecting unit has not detected the high luminance pixel.

In this case, the white balance adjusting amount calculating unit may calculate the white balance adjusting amount based on the information of the colors of the entire image when a size of the face region of the object in the image is smaller than a predetermined size.

According to another embodiment of the present disclosure, there is provided an image processing method performed by an image processing apparatus including: detecting an eye region of an object in an image; detecting a high luminance pixel with a higher luminance than a predetermined luminance based on pixels in the detected eye region; estimating information of a light source color from the detected high luminance pixel; calculating a white balance adjusting amount based on the information of the estimated light source color; and adjusting a white balance of at least a partial region of the image by using the calculated white balance adjusting amount.

According to still another embodiment of the present disclosure, there is provided a program which causes an image processing apparatus to function as: an eye region detecting unit which detects an eye region of an object in an image; a high luminance pixel detecting unit which detects a high luminance pixel with a higher luminance than a predetermined luminance based on pixels in the eye region detected by the eye region detecting unit; a light source color estimating unit which estimates information of a light source color from the high luminance pixel detected by the high luminance pixel detecting unit; a white balance adjusting amount calculating unit which calculates a white balance adjusting amount based on the information of the light source color estimated by the light source color estimating unit; and an image processing unit which adjusts a white balance of at least a partial region in the image by using the white balance adjusting amount calculated by the white balance adjusting amount calculating unit.

According to the embodiment of the present disclosure, an eye region of an object in an image is detected, a high luminance pixel with a higher luminance than a predetermined luminance is detected based on pixels in the detected eye region, and information of a light source color is estimated from the detected high luminance pixel. Then, a white balance adjusting amount is calculated based on the information of the estimated light source color, and a white balance of at least a partial region of the image is adjusted by using the calculated white balance adjusting amount.

According to the present disclosure, it is possible to optimally perform white balance control.

### BRIEF DESCRIPTION OF THE DRAWINGS

FIG. 1 is a diagram showing a configuration example of an imaging apparatus as an image processing apparatus to which the present technology is applied.

FIG. 2 is a block diagram showing configurations of an image analyzing unit and a white balance adjusting amount determining unit.

FIG. 3 is a diagram illustrating a face region and an eye region in a captured image.

FIG. 4 is a diagram illustrating a region where a light source is imaged in the eye region.

FIG. 5 is a diagram illustrating a discriminant analysis method.

FIGS. 6A and 6B are diagrams illustrating extraction of the region where the light source is imaged with the use of the discriminant analysis method.

FIG. 7 is a flowchart illustrating image recording processing.

FIG. 8 is a flowchart illustrating an example of white balance processing.

FIG. 9 is a flowchart illustrating an example of face-localized white balance processing.

FIG. 10 is a flowchart illustrating another example of face-localized white balance processing.

FIG. 11 is a flowchart illustrating an example of normal white balance processing.

FIG. 12 is a flowchart illustrating another example of white balance processing.

FIG. 13 is a flowchart illustrating a still another example of white balance processing.

FIG. 14 is a flowchart illustrating another example of white balance processing.

FIG. 15 is a block diagram showing a configuration example of a computer.

### DETAILED DESCRIPTION OF EMBODIMENTS

Hereinafter, a description will be given of an embodiment for implementing the present disclosure (hereinafter, simply referred to as an embodiment).

### Configuration of Imaging Apparatus According to Present Technology

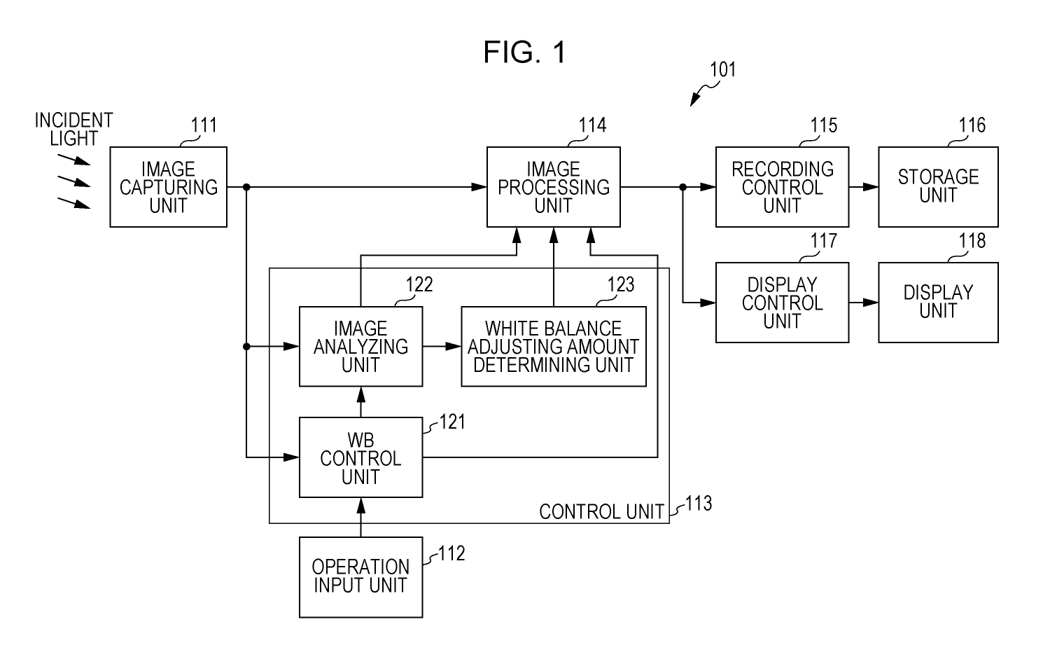

FIG. 1 is a diagram showing a configuration example of an imaging apparatus as an image processing apparatus to which the present technology is applied.

In the example shown in FIG. 1, an imaging apparatus 101 includes an image capturing unit 111, an operation input unit 112, a control unit 113, an image processing unit 114, a recording control unit 115, a storage unit 116, a display control unit 117, and a display unit 118.

The image capturing unit 111 outputs RGB data of a captured image to the control unit 113 and the image processing unit 114. The image capturing unit 111 is configured by a lens group for collecting incident light, a diaphragm for adjusting a light amount, a shutter for adjusting exposure time, an image sensor for performing photoelectric conversion on the incident light, a readout circuit, an amplifier circuit, an A/D converter, and the like.

The operation input unit 112 is configured by a dial, a button, and the like so as to input signals corresponding to user setting, selection, and operations to the control unit 113. For example, the operation input unit 112 inputs a signal which represents an imaging mode selected by a user or a set white balance processing method (white balance mode) to the control unit 113 at the timing of imaging. In addition, when the white balance mode is a manual white balance (MWB) mode, the operation input unit 112 also inputs a white balance adjusting amount to the control unit 113 in response to the user operation.

The control unit 113 analyzes the RGB data of the image which has been input from the image capturing unit 111 and acquires a white balance adjusting amount. At this time, the control unit 113 acquires the white balance adjusting amount by a processing method corresponding to an imaging mode which has been selected and input by the user via the operation input unit 112 and to a signal which represents the white balance mode. Alternatively, the control unit 113 acquires the white balance adjusting amount by a processing method corresponding to a brightness level of the image which has been input from the image capturing unit 111.

In addition, color analysis processing by the control unit 113 may be performed by directly using the RGB signals or may be performed by converting the RGB signals into YCrCb signals, for example, in accordance with convenience of the analysis.

The control unit 113 supplies the signals which represent the imaging mode and the white balance mode and the white balance adjusting amount to the image processing unit 114.

The image processing unit 114 performs image signal processing suitable for an object, such as white balance or a tone curve, on the captured image which has been input from the image capturing unit 111 and outputs the image after the image processing to the recording control unit 115 and the display control unit 117.

Here, if the signal which is sent from the control unit 113 and represents a white balance mode indicates an automatic white balance (AWB) mode, the white balance adjusting amount which has been acquired by the control unit 113 is input. Accordingly, the image processing unit 114 adjusts the white balance of at least a partial region of the captured image, which has been input from the image capturing unit 111, based on the imaging mode and the white balance adjusting amount input from the control unit 113.

In addition, if the signal which is sent from the control unit 113 and represents a white balance mode indicates the manual white balance (MWB) mode, the white balance adjusting amount corresponding to a user operation is also input from the control unit 113. Accordingly, the image processing unit 114 adjusts the white balance of the captured image, which has been input from the image capturing unit 111, based on the white balance adjusting amount corresponding to the user operation.

The recording control unit 115 converts the image after the image processing by the image processing unit 114 into a JPEG image file, for example, and records the JPEG image file or the like in the storage unit 116. The storage unit 116 is configured by a memory card, for example, and stores a JPEG image file or the like thereon.

The display control unit 117 causes the display unit 118 to display the image after the image processing by the image processing unit 114. The display unit 118 is configured by a Liquid Crystal Display (LCD) or the like and displays an image from the display control unit 117.

Furthermore, the control unit 113 includes a White Balance (WB) control unit 121, an image analyzing unit 122, and a white balance adjusting amount determining unit 123. The image which has been input from the image capturing unit 111 is input to the image analyzing unit 122, and as necessary, supplied to the WB control unit 121.

The WB control unit 121 controls operations of the image analyzing unit 122 in accordance with the signals which represent the imaging mode and the white balance mode selected and input by the user via the operation input unit 112. Alternatively, the WB control unit 121 controls operations of the image analyzing unit 122 in accordance with a brightness level of the image which has been input from the image capturing unit 111. In addition, the WB control unit 121 supplies the signals which represent the imaging mode and the white balance mode to the image processing unit 114.

The image analyzing unit 122 is controlled by the WB control unit 121 to detect a face region and an eye region of a person in the captured image from the RGB data of the captured image and detects a region corresponding to a light source which has been imaged in the eye region by a discriminant method using pixel data. In addition, the image analyzing unit 122 is controlled by the WB control unit 121 to detect an achromatic region from the entire captured image information. The image analyzing unit 122 supplies at least one of RGB data of the region corresponding to the light source and RGB data of the achromatic region to the white balance adjusting amount determining unit 123.

In addition, the image analyzing unit 122 supplies information on the detected face region to the image processing unit 114.

The white balance adjusting amount determining unit 123 estimates a light source color at the time of imaging from respective input digital data of R, G, and B and acquires a white balance gain (adjusting amount). The white balance adjusting amount determining unit 123 supplies the acquired white balance adjusting amount to the image processing unit 114.

### Configurations of Image Analyzing Unit and White Balance Adjusting Amount Determining Unit

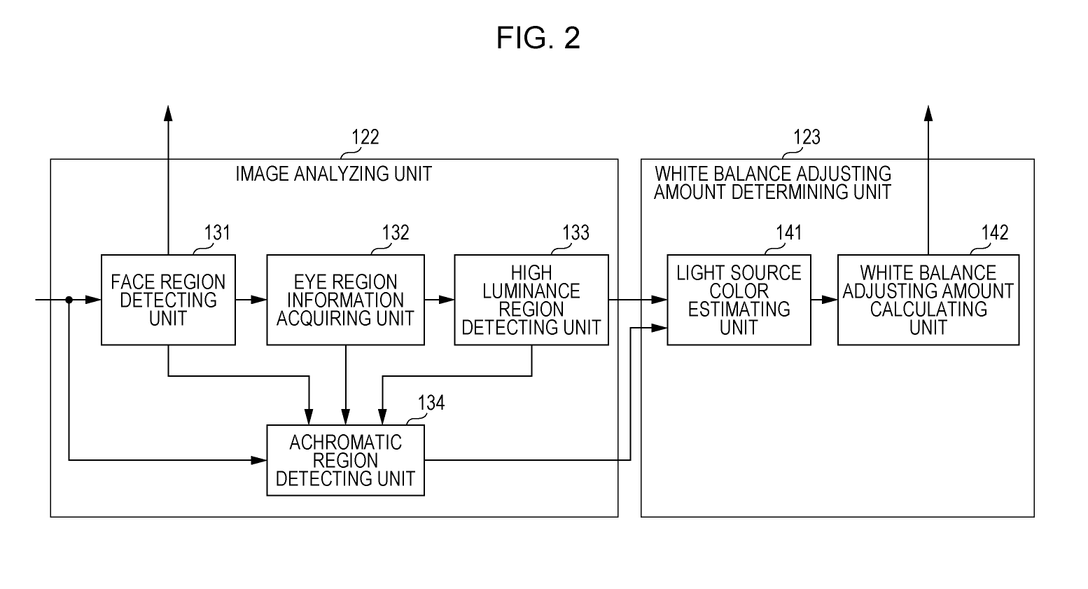

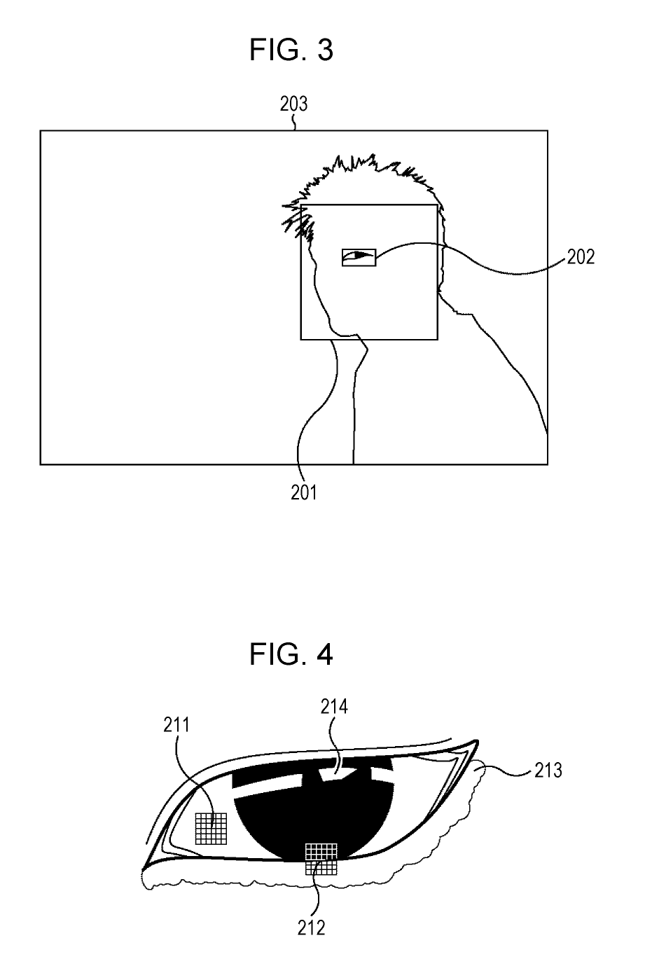

FIG. 2 is a block diagram showing a configuration example of the image analyzing unit and the white balance adjusting amount determining unit. The configuration example in FIG. 2 will be described with reference to FIGS. 3 and 4 as necessary.

The image analyzing unit 122 includes a face region detecting unit 131, an eye region information acquiring unit 132, a high luminance region detecting unit 133, and an achromatic region detecting unit 134.

The white balance adjusting amount determining unit 123 includes a light source color estimating unit 141 and a white balance adjusting amount calculating unit 142.

The face region detecting unit 131 is controlled by the WB control unit 121 to detect a face region of a person in the captured image from the RGB data of the captured image and supply information on the detected face region to the eye region information acquiring unit 132 and the image processing unit 114. That is, the face region detecting unit 131 detects a face region 201 of a person from a captured image 203 shown in FIG. 3.

The eye region information acquiring unit 132 detects an eye region within the face region which has been detected by the face region detecting unit 131, acquires pixel information of the detected eye region, and supplies the pixel information (RGB information for each pixel) in the acquired eye region to the high luminance region detecting unit 133. That is, the eye region information acquiring unit 132 detects an eye region 202 from the face region 201 shown in FIG. 3.

Here, if a plurality of eye regions are detected, integral of the RGB data of the respective regions may be used for estimating a light source color, or alternatively, a main object may be picked up based on information on sizes of faces and eyes, and light source estimation may be performed thereon. Alternatively, light source estimation may be performed for each eye region, and white balance processing may be individually performed.

The high luminance region detecting unit 133 detects high luminance region with a higher luminance than a predetermined luminance in order to extract only pixel information on a light source part, which has been imaged in the eyeball, from the RGB information on the entire eye region which has been acquired by the eye region information acquiring unit 132.

That is, the high luminance region detecting unit 133 eliminates pixel information on a white part of the eye 211, a black part of the eye 212, and a skin color part 213 shown in FIG. 4 from the entire eye region based on the RGB information and the YCbCr information. In doing so, the pixel information of the light source part 214 shown in FIG. 4 is extracted.

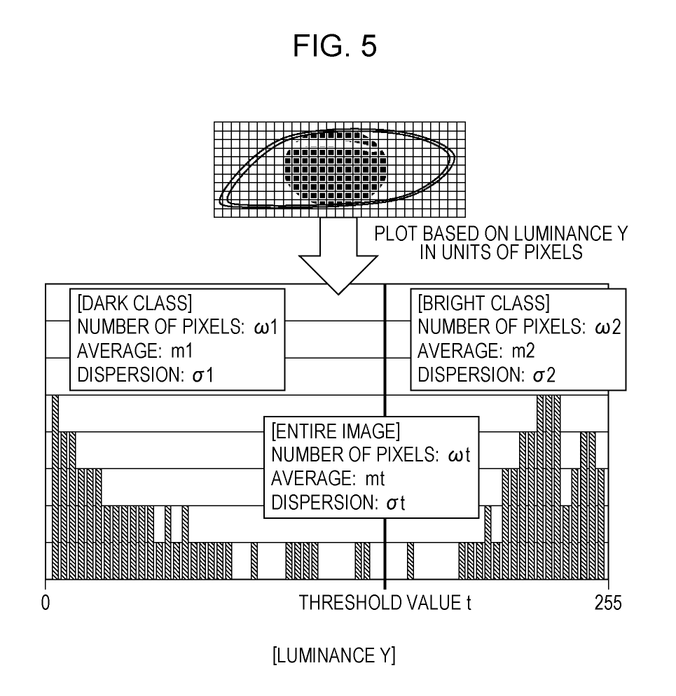

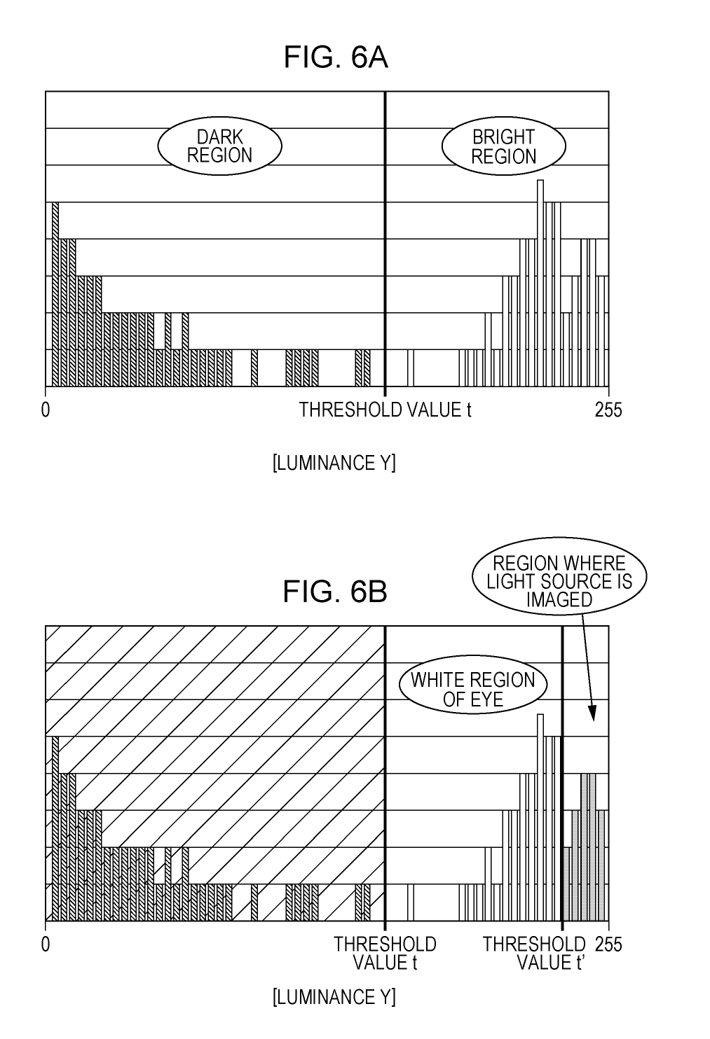

It is possible to eliminate the skin color part, the black part of the eye, and the white part of the eye by repeating binarization processing based on dispersion by using pixel luminance information Y as a parameter, for example. In addition, the binarization processing using dispersion will be described below in detail with reference to FIGS. 5, 6A, and 6B.

The pixel information of the detected high luminance region is supplied as pixel information of the light source part 214 to the light source color estimating unit 141.

If no face region has been detected by the face region detecting unit 131, or if no eye region has been detected by the eye region information acquiring unit 132, the face region detecting unit 131 or the eye region information acquiring unit 132 causes the achromatic region detecting unit 134 to detect an achromatic region. Furthermore, if no high luminance region has been detected by the high luminance region detecting unit 133, the high luminance region detecting unit 133 causes the achromatic region detecting unit 134 to detect an achromatic region. That is, the image analyzing unit 122 performs normal white balance processing.

The achromatic region detecting unit 134 is controlled by the WB control unit 121 to detect an achromatic region from the RGB data of the captured image and supply pixel information of the detected achromatic region to the light source color estimating unit 141.

At least one of the pixel information of the high luminance region from the high luminance region detecting unit 133 and the pixel information of the achromatic region from the achromatic region detecting unit 134 is input to the light source color estimating unit 141. The light source color estimating unit 141 plots the RGB signal for each pixel as an input on a plane which includes two axes of R/G and B/G, acquire an weighted average, and estimates a light source color depending on a position in a light source frame which has been set in advance on the plane. In addition, the light source estimation method is not limited thereto. The light source color estimating unit 141 supplies information on the estimated light source color to the white balance adjusting amount calculating unit 142.

The white balance adjusting amount calculating unit 142 calculates a gain (adjusting amount) which satisfies R=G=B for the light source color which has been estimated by the light source color estimating unit 141 and supplies the calculated white balance adjusting amount to the image processing unit 114.

The image processing unit 114 performs white balance control by applying the white balance adjusting amount to a target part in the image.

For example, when normal white balance processing is performed, a light source color is estimated from the pixel information of the achromatic region in the entire image, an adjusting amount is obtained, and the image processing unit 114 applies the adjusting amount, which has been acquired from the achromatic region, to the entire captured image.

On the other hand, when white balance processing according to the present technology is performed, for example, a light source color is estimated from the pixel information of the high luminance region which has been detected from the eye region, an adjusting amount is acquired, and the image processing unit 114 applies the adjusting amount, which has been acquired from the high luminance region, to the face region in the captured image.

Hereinafter, the white balance processing according to the present technology will be also referred to as face-localized white balance processing.

In doing so, it is possible to perform appropriate white balance control on a light source with which illuminates the face. As a result, it is possible to suppress color deviation of white balance in the face region even if an achromatic object due to non-estimatable light source is present in an imaging scene.

It is also possible to estimate a light source color from the pixel information of the achromatic region and apply the adjusting amount, which has been acquired form the achromatic region, to regions other than the face region in the captured image when the white balance adjusting amount is applied to the face region, in the image processing unit 114.

In doing so, it is possible to optimally perform white balance control even if different kinds of lighting illuminate the face region and the other regions in the captured image.

According to the present technology, it is possible to optimally perform white balance adjustment by information on a light source color which has been imaged in an eye region as described above.

If a part where a light source has been imaged is not detected in the pixel information on the white part of the eye, it is possible to estimate the light source from an integrated value of the pixels in the white region of the eye. In doing so, it is possible to calculate a white balance adjusting amount even in a case where the light source has not been imaged in the white parts of the eyes due to image capturing in a shady area or the like. However, there are influences of individual differences and hyperemia in this case.

### High Luminance Region Detecting Method

Next, a description will be given of the binarization processing using dispersion, which is used as one of the high luminance region detecting methods by the high luminance region detecting unit 133, with reference to FIG. 5.

The binarization processing using dispersion is a discriminant analysis method, which is a method for automatically performing binarization by acquiring a threshold value which maximizes a degree of separation (separation metrics). The discriminant analysis method is also referred to as Otsu's binarization.

When plotting is performed based on luminance Y in units of pixels in the eye region which has been acquired by the eye region information acquiring unit 132 and binarization with a threshold t is performed, ω1 represents the number of pixels on a side on which a luminance value is smaller than the threshold value t (dark class), m1 represents an average thereof, and σ1 represents dispersion thereof as shown in FIG. 5, for example. In addition, ψ2 represents the number of pixels on the side on which a luminance value is larger (bright class), m2 represents an average thereof, σ2 represents dispersion thereof, cot represents the number of pixels in the entire image, mt represents an average thereof, and σt represents dispersion thereof. At this time, intra-class dispersion σw2 is expressed by the following Equation (1).

$${σ}_{w}^{2} = \frac{{ω}_{1} {σ}_{1}^{2} + {ω}_{2} {σ}_{2}^{2}}{{ω}_{1} + {ω}_{2}} \qquad ( 1 )$$

Inter-class dispersion σb2 is expressed by the following Equation (2).

$$\begin{matrix}{σ}_{b}^{2} = \frac{{{ω}_{1} ( {m}_{1} - {m}_{t} )}^{2} + {{ω}_{2} ( {m}_{2} - {m}_{t} )}^{2}}{{ω}_{1} + {ω}_{2}} \\ = \frac{{ω}_{1} {{ω}_{2} ( {m}_{1} - {m}_{2} )}^{2}}{{( {ω}_{1} + {ω}_{2} )}^{2}}\end{matrix} \qquad ( 2 )$$

Here, since the entire dispersion σt can be expressed by the following Equation (3), a degree of separation which is a ratio between the obtained inter-class dispersion and the intra-class dispersion is as the following Equation (4), and it is only necessary to acquire the threshold t which maximizes the degree of separation.

$$\begin{matrix}{σ}_{t}^{2} = {σ}_{b}^{2} + {σ}_{w}^{2} & ( 3 ) \\ \frac{{σ}_{b}^{2}}{{σ}_{w}^{2}} = \frac{{σ}_{b}^{2}}{{σ}_{t}^{2} - {σ}_{b}^{2}} & ( 4 )\end{matrix}$$

Since the entire dispersion σt is constant regardless of the threshold value in practice, it is only necessary to acquire a threshold value, which maximizes the degree of separation, for the inter-class dispersion σb2. Furthermore, the denominator of Equation (2) for inter-class dispersion is also constant regardless of the threshold value, and therefore, it is only necessary to acquire a threshold value which maximizes the numerator ω1ω2(m1−m2)2 of the inter-class dispersion.

It is possible to specify a light source which has been imaged by repeating the discriminant analysis method as described above. In the first execution of the discriminant analysis method, for example, it is possible to acquire the threshold value t and separate a dark region from a bright region based on the pixel information of the eye region as shown in FIG. 6A. In doing so, the white region of the eye and the region where the light source has been imaged can be extracted.

Furthermore, it is possible to acquire a threshold value t′ and separate the white region of the eye from the region where the light source has been imaged from the pixel information of the bright region which has been determined in the first execution as shown in FIG. 6B by the second execution of the discriminant analysis method. In doing so, a region where the light source has been imaged, which is necessary for the light source estimation processing, can be extracted.

### Image Recording Processing

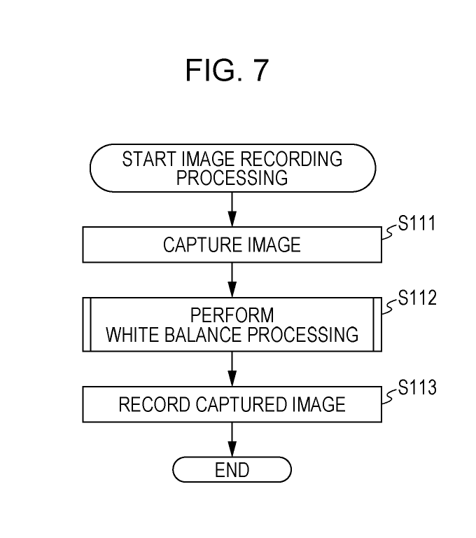

Next, a description will be given of image recording processing by the imaging apparatus 101 with reference to a flowchart in FIG. 7.

In Step S111, the image capturing unit 111 captures an image. That is, the image capturing unit 111 performs predetermined signal processing on an image signal, which has been obtained by receiving light by an image sensor and subjecting the light to photoelectric conversion, and outputs the image signal to the control unit 113 and the image processing unit 114.

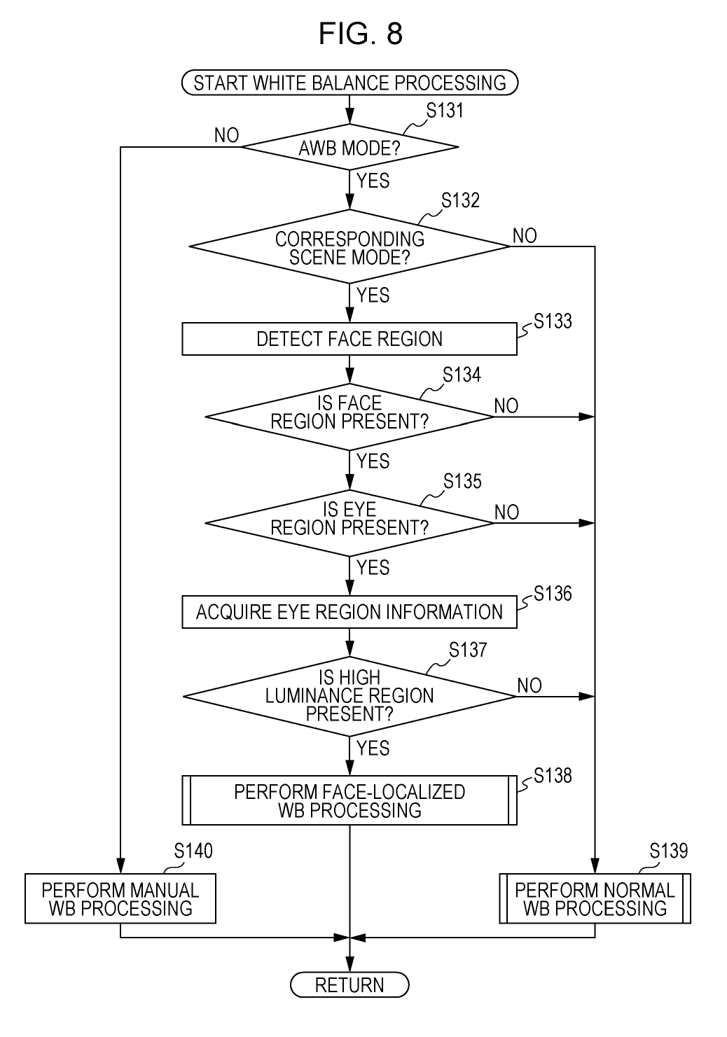

In Step S112, the control unit 113 and the image processing unit 114 perform white balance processing. The white balance processing will be described later with reference to FIG. 8. By the processing in Step S112, the white balance processing is performed on the image supplied from the image capturing unit 111, and the captured image after the processing is output to the recording control unit 115.

In Step S113, the recording control unit 115 converts the captured image supplied form the image processing unit 114 into a JPEG image file and records the JPEG image file in the storage unit 116.

### Example of White Balance Processing

Next, a description will be given of white balance processing in Step S112 in FIG. 7 with reference to a flowchart in FIG. 8.

In the example in FIG. 8, white balance processing in accordance with an existing imaging mode will be described. That is, it is necessary that a person be present in an imaged scene when the face-localized white balance processing according to the present technology is performed. Thus, a description will be given of a case where white balance processing is differently performed depending on whether or not a user has intentionally selected the imaging mode for a case where a person is present, as a method for performing the face-localized white balance processing according to the present technology in the example in FIG. 8.

In Step S131, the WB control unit 121 determines whether or not the white balance mode at the time of imaging is the Automatic White Balance (AWB) mode. If it is determined Step S131 that the white balance mode is the AWB mode, that is, in a case where a color temperature of a light source is estimated from the image and white balance processing is automatically performed, the processing proceeds to Step S132.

In Step S132, the WB control unit 121 determines whether or not the imaging mode is a corresponding scene mode. If the user has intentionally selected a portrait mode, a night scene+person mode, or the like in scene mode selection, it is determined that the white balance processing according to the present technology can be applied to the scene, and the processing proceeds to Step S133. This is because a light source for a person differs from a light source for background in many cases when the portrait mode or the night scene+person mode is selected as the scene mode. In addition, the portrait mode and the night scene+person mode are examples, and the same is true in other imaging modes as long as the imaging modes are for imaging persons. In the white balance processing, Step S132 itself may not be provided.

In Step S133, the face region detecting unit 131 is controlled by the WB control unit 121 to detect a face region of a person in the captured image from RGB data of the captured image. At this time, not only presence of a face but also information relating to a size (the total number of pixels) of the detected face region with respect to the entire image region is also acquired. The face region detecting unit 131 supplies information of the detected face region to the eye region information acquiring unit 132 and the image processing unit 114.

In Step S134, the face region detecting unit 131 determines whether or not there is a face region in the captured image based on the acquired information which represents presence of face region and the size of the face region. If it is determined in Step S134 that there is a face region, the processing proceeds to Step S135.

In Step S135, the eye region information acquiring unit 132 detects an eye region in the face region and determines whether or not there is an eye region. If it is determined in Step S135 that there is an eye region, the processing proceeds to Step S136. In Step S136, the eye region information acquiring unit 132 acquires pixel information of the detected eye region (eye region information) and supplies the pixel information of the acquired eye region to the high luminance region detecting unit 133.

In Step S137, the high luminance region detecting unit 133 detects a high luminance region with a higher luminance than a predetermined luminance and determines whether or not there is a high luminance region. If it is determined In Step S137 that there is a high luminance region, the high luminance region detecting unit 133 supplies the information of the detected high luminance region as pixel information of a light source part to the light source color estimating unit 141, and the processing proceeds to Step S138.

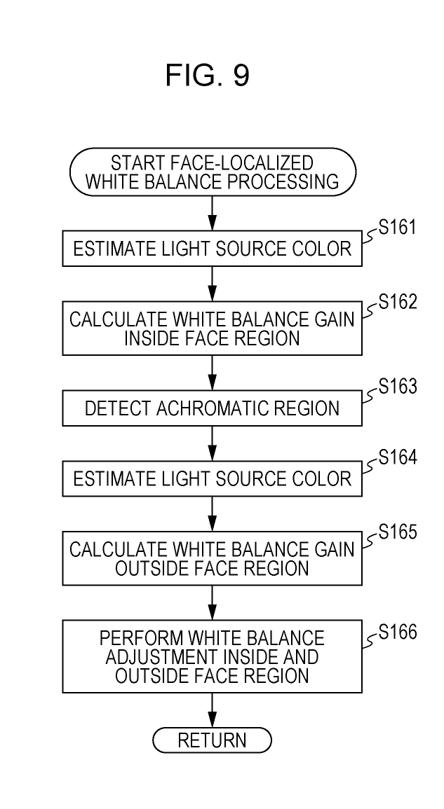

In Step S138, the white balance adjusting amount determining unit 123 and the image processing unit 114 perform the face-localized WB processing. The face-localized WB processing will be described later with reference to FIG. 9. In doing so, the white balance of the face region is locally adjusted.

In addition, if it is determined in Step S132 that the imaging mode is not the corresponding scene mode, that is, in a case where the user has intentionally selected a landscape/night scene mode, a food mode, a fireworks mode, or the like, for example as an imaging mode for imaging objects other than persons, the processing proceeds to Step S139.

If it is determined in Step S134 that there is no face region, the processing proceeds to Step S139. For example, if there is no face region in the imaged scene, or if information indicates that the size of the face region with respect to the entire image region is smaller than a predetermined threshold value even when the face region is present, image information of an eye region which is necessary for performing the face-localized white balance processing is not effectively acquired, and therefore, it is determined that there is no face region.

If it is determined in Step S135 that there is no eye region, the processing proceeds to Step S139. Since effective pixel information is not obtained if an eye region is not sufficiently larger than a certain threshold value or it is found that a person is closing eyes even there is an eye region, it is determined that there is no eye region in Step S135.

If it is determined in Step S137 that there is no high luminance region, that is, if there is no high luminance pixel with a luminance which exceeds a preset threshold value, it is determined that the light source has not been imaged, and the processing proceeds to Step S139.

In Step S139, the achromatic region detecting unit 134 and the white balance adjusting amount determining unit 123 perform normal white balance processing. The normal white balance processing will be described later with reference to FIG. 11. In doing so, white balance of the entire captured image is corrected.

On the other hand, if it is determined in Step S131 that the white balance mode is not the AWB mode, the processing proceeds to Step S140. For example, the user voluntarily selects white balance processing which has been preset for each light source or performs white balance processing for which the user inputs a color temperature of a light source. In such a case, it is determined in Step S131 that the white balance mode is not the AWB mode, and the processing proceeds to Step S140.

In Step S140, the control unit 113 and the image processing unit 114 perform manual WB processing. That is, the control unit 113 supplies a white balance adjusting amount, which has been determined based on the user operation/selection input via the operation input unit 112, to the image processing unit 114. The image processing unit 114 adjusts the white balance of the entire image by using the white balance adjusting amount which has been determined based on the user operation/selection supplied from the control unit 113.

### Example of Face-Localized White Balance Processing

Next, a description will be given of the face-localized white balance processing in Step S138 in FIG. 8 with reference to the flowchart in FIG. 9.

In Step S137 in FIG. 8, information of the high luminance region is supplied as pixel information of the light source part to the light source color estimating unit 141.

In response to the pixel information, the light source color estimating unit 141 plots the RGB signal for each pixel in the high luminance region as input on a plane which includes two axes of R/G and B/G and acquires a weighted average in Step S161. Then, the light source color estimating unit 141 estimates a light source color depending on a position in a light source frame determined in advance on the plane. The light source color estimating unit 141 supplies information of the estimated light source color to the white balance adjusting amount calculating unit 142.

In Step S162, the white balance adjusting amount calculating unit 142 calculates a white balance gain in the face region with respect to the light source color which has been estimated by the light source color estimating unit 141 and supplies the calculated white balance adjusting amount to the image processing unit 114.

In Step S163, the achromatic region detecting unit 134 is controlled by the WB control unit 121 to detect an achromatic region from the RGB data of the captured image and supplies pixel information of the detected achromatic region to the light source color estimating unit 141.

In Step S164, the light source color estimating unit 141 plots an RGB signal for each pixel in the achromatic region as an input on the plane which includes two axes of R/G and B/G, acquires a weighted average, and estimates a light source color depending on a position in the light source frame which has been determined in advance on the plane. The light source color estimating unit 141 supplies information of the estimated light source color to the white balance adjusting amount calculating unit 142.

In Step S165, the white balance adjusting amount calculating unit 142 calculates a white balance gain outside the face region with respect to the light source color which has been estimated by the light source color estimating unit 141 and supplies the calculated white balance adjusting amount to the image processing unit 114.

In Step S166, the image processing unit 114 adjusts the white balance inside and outside the face region in the captured image by using the white balance adjusting amounts inside and outside the face region based on the information on the face region supplied from the face region detecting unit 131.

That is, the image processing unit 114 adjusts the white balance inside the face region by using the white balance gain inside the face region, which has been calculated in Step S162. On the other hand, the image processing unit 114 adjusts the white balance outside the face region by using the white balance gain other than the face region, which has been calculated in Step S165.

As described above, it is possible to optimally perform white balance control even if different kinds of lighting illuminate the face region and the other region in the captured image.

In addition, the white balance may be adjusted only in the face region as will be described below.

### Example of Face-Localized White Balance Processing

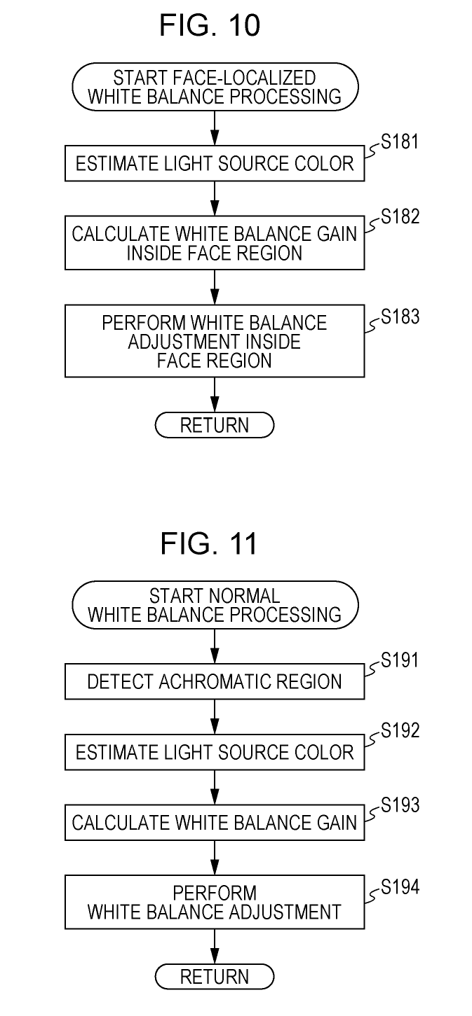

Next, a description will be given of another example of the face-localized white balance processing in Step S138 in FIG. 8 with reference to the flowchart in FIG. 10.

In Step S137 in FIG. 8, information of the high luminance region is supplied as pixel information of the light source part to the light source color estimating unit 141.

In response to the pixel information, the light source color estimating unit 141 plots an RGB signal for each pixel in the high luminance region as an input on the plane which includes the two axes of R/G and B/G and acquires a weighted average in Step S181. Then, the light source color estimating unit 141 estimates a light source color depending on a position, at which the RGB signal for each pixel as an input is present, in the light source frame which has been determined in advance on the plane. The light source color estimating unit 141 supplies information of the estimated light source color to the white balance adjusting amount calculating unit 142.

In Step S182, the white balance adjusting amount calculating unit 142 calculates a white balance gain in the face region with respect to the light source color which has been estimated by the light source color estimating unit 141 and supplies the calculated white balance adjusting amount to the image processing unit 114.

In Step S183, the image processing unit 114 adjusts the white balance in the face region in the captured image by using the white balance adjusting amount in the face region based on the information of the face region supplied from the face region detecting unit 131.

As described above, it is possible to appropriately perform white balance control with respect to a light source which illuminates a face. As a result, it is possible to suppress color deviation of the white balance in the face region even if an achromatic object due to non-estimatable light source is present in an imaging scene.

### Example of Normal White Balance Processing

Next, a description will be given of another example of normal white balance processing in Step S139 in FIG. 8 with reference to the flowchart in FIG. 11.

In Step S191, the achromatic region detecting unit 134 is controlled by the WB control unit 121 to detect an achromatic region from the RGB data of the captured image in accordance with the respective detection results from the face region detecting unit 131, the eye region information acquiring unit 132, and the high luminance region detecting unit 133. The achromatic region detecting unit 134 supplies pixel information of the detected achromatic region to the light source color estimating unit 141.

In Step S192, the light source color estimating unit 141 plots an RGB signal for each pixel in the achromatic region as an input on the plane which includes the two axes of R/G and B/G, acquires a weighted average, and estimates a light source color depending on a position in the light source frame which has been determined in advance on the plane. The light source color estimating unit 141 supplies information of the estimated light source color to the white balance adjusting amount calculating unit 142.

In Step S193, the white balance adjusting amount calculating unit 142 calculates a white balance gain with respect to the light source color which has been estimated by the light source color estimating unit 141 and supplies the calculated white balance adjusting amount to the image processing unit 114.

In Step S194, the image processing unit 114 adjusts the white balance of the captured image by using the white balance adjusting amount.

As described above, the normal white balance adjusting processing is performed in a case of an imaging mode for which the face-localized white balance processing is not necessary or in a case where a face region, an eye region, or a high luminance region is not detected.

### Another Example of White Balance Processing

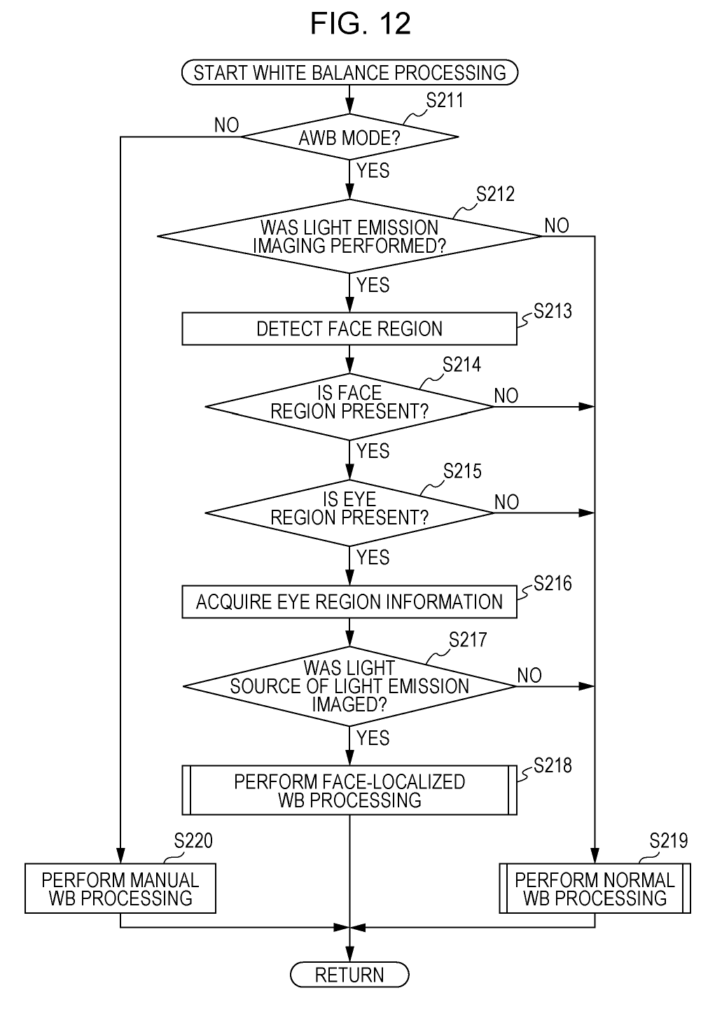

Next, a description will be given of the white balance processing in Step S112 in FIG. 7 with reference to the flowchart in FIG. 12.

In the example in FIG. 12, white balance processing in accordance with whether or not imaging is performed with light emission will be described. That is, in a case of imaging with light emission in front of a person, a white balance adjusting amount which is appropriate for the person irradiated with strobe light differs from a white balance adjusting amount which is appropriate for background which the strobe light does not reach. If white balance processing is performed on the entire frame with the same white balance adjusting amount, color cast occurs in the image of the person in some cases. In the example in FIG. 12, a description will be given of a case where white balance processing is differently performed depending on whether or not strobe light has been emitted, as a method for performing the face-localized white balance processing according to the present technology.

In Step S211, the WB control unit 121 determines whether or not the white balance mode at the time of imaging is the Automatic White Balance (AWB) mode. If it is determined in Step S211 that the white balance mode is the AWB mode, that is, in a case of estimating a color temperature of the light source from the image and automatically performing white balance processing, the processing proceeds to Step S212.

In Step S212, the WB control unit 121 determines whether or not imaging with light emission has been performed. If the user has forcibly selected light emission or imaging has been performed with automatic emission of strobe light, it is determined in Step S212 that imaging with light emission has been performed, and the processing proceeds to Step S213.

In Step S213, the face region detecting unit 131 is controlled by the WB control unit 121 to detect a face region of a person in the captured image from RGB data of the captured image. At this time, information not only on presence of a face but also on a size (the total number of pixels) of the detected face region with respect to the entire image region is also acquired. The face region detecting unit 131 supplies information of the detected face region to the eye region information acquiring unit 132 and the image processing unit 114.

In Step S214, the face region detecting unit 131 determines whether or not there is a face region in the captured image based on the acquired information on the presence of the face region and the size of the face region. If it is determined in Step S214 that there is a face region, the processing proceeds to Step S215.

In Step S215, the eye region information acquiring unit 132 detects an eye region in the face region and determines whether or not there is an eye region. If it is determined in Step S215 that there is an eye region, the processing proceeds to Step S216. In Step S216, the eye region information acquiring unit 132 acquires pixel information of the detected eye region (eye region information) and supplies the acquired pixel information of the eye region to the high luminance region detecting unit 133.

In Step S217, the high luminance region detecting unit 133 determines whether or not a light source of light emission (strobe light) has been imaged. That is, in Step S217, it is determined whether or not there is a high luminance region corresponding to color information of a strobe light source, which has been set in advance, in the pixel information of the eye region. If it is determined in Step S217 that the light source of the light emission has been imaged, that is, if it is determined that there is a high luminance region, the high luminance region detecting unit 133 supplies information of the detected high luminance region as pixel information of the light source part to the light source color estimating unit 141, and the processing proceeds to Step S218.

In Step S218, the white balance adjusting amount determining unit 123 and the image processing unit 114 perform face-localized WB processing. Since the face-localized WB processing is basically the same as the processing described above with reference to FIG. 9, repeated description thereof is omitted. However, an adjusting amount for the strobe light source is acquired, and white balance of the face region is locally adjusted in this case. In addition, it is also possible to preset a white balance adjusting amount for the strobe light source and utilize the preset white balance adjusting amount for the strobe light source in a case where light emission of strobe light has been imaged.

If the user has selected a mode with no light emission or strobe light has not been automatically emitted, it is determined in Step S212 that the imaging has not been performed with light emission, and the processing proceeds to Step S219.

If it is determined in Step S214 that there is no face region, the processing proceeds to Step S219. If there is no face region in the imaged scene, or if information indicates that the size of a face region with respect to the entire image region is smaller than a predetermined threshold value even when the face region is present, it is not possible to effectively acquire image information in the eye region which is necessary for performing the face-localized white balance processing, and therefore, it is determined that there is no face region.

If it is determined in Step S215 that there is no eye region, the processing proceeds to Step S219. Since effective pixel information is not obtained if an eye region is not sufficiently larger than a certain threshold value or it is found that a person is closing eyes even there is an eye region, it is determined that there is no eye region in Step S215.

If it is determined in Step S217 that there is no high luminance region, that is, there is no high luminance pixel with a luminance which exceeds a preset threshold value, it is determined that a light source has not been imaged, and the processing proceeds to Step S219.

In Step S219, the achromatic region detecting unit 134 and the white balance adjusting amount determining unit 123 performs normal white balance processing. Since the normal white balance processing is basically the same as the processing described above with reference to FIG. 11, repeated description thereof will be omitted. As described above, white balance of the entire captured image is corrected.

On the other hand, if it is determined in Step S211 that the white balance mode is not the AWB mode, the processing proceeds to Step S220. For example, the user voluntarily selects white balance processing which has been preset for each light source or performs white balance processing for which the user inputs a color temperature of a light source. In such a case, it is determined in Step S211 that the white balance mode is not the AWB mode, and the processing proceeds to Step S220.

In Step S220, the control unit 113 and the image processing unit 114 perform manual WB processing. That is, the control unit 113 supplies a white balance adjusting amount, which has been determined based on a user operation/selection input via the operation input unit 112, to the image processing unit 114. The image processing unit 114 adjusts the white balance of the entire image by using the white balance adjusting amount which has been determined based on the user operation/selection supplied from the control unit 113.

### Example of White Balance Processing

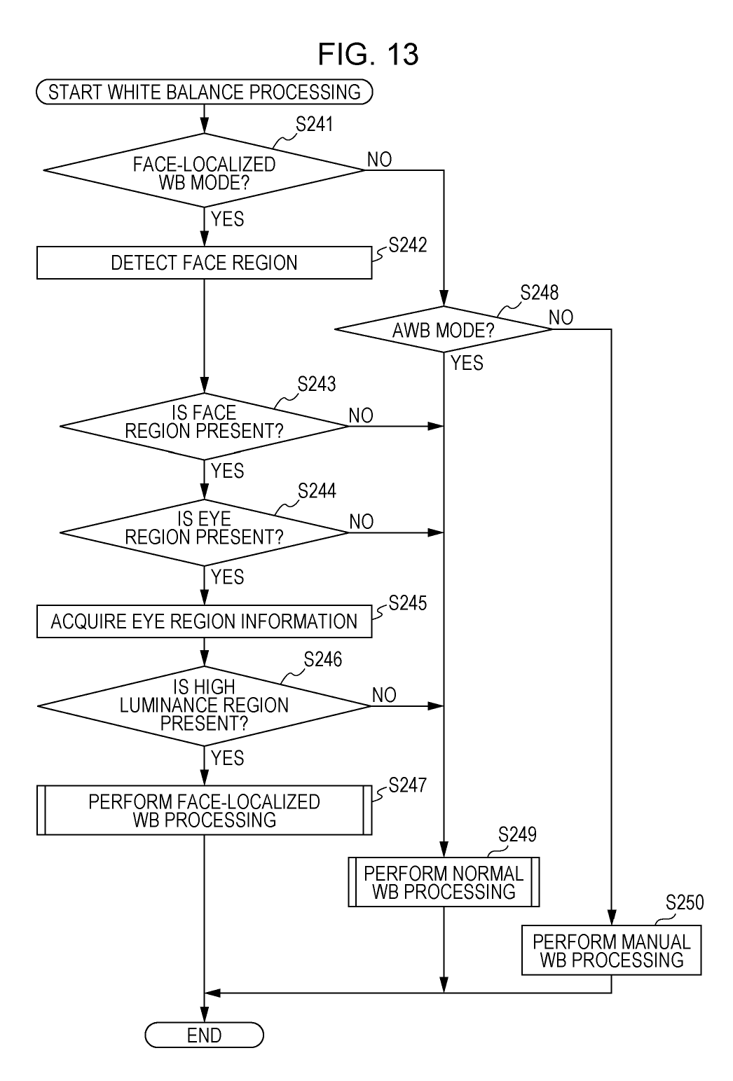

Next, a description will be given of another example of the white balance processing in Step S112 in FIG. 7 with reference to the flowchart in FIG. 13.

In the example in FIG. 13, white balance processing in response to the selection of a newly prepared face-localized white balance mode will be described. That is, a face-localized white balance mode for performing the face-localized white balance processing according to the present technology is prepared in advance in a user-selectable state as one option among a plurality of white balance modes. In the example in FIG. 13, a case where white balance processing is differently performed as a method for performing the face-localized white balance processing according to the present technology depending on whether or not the face-localized white balance mode has been selected by the user will be described.

In Step S241, the WB control unit 121 determines whether or not the white balance mode at the time of imaging is the face-localized WB mode. If it is determined in Step S241 that the white balance mode is the face-localized WB mode, the processing proceeds to Step S242.

In Step S242, the face region detecting unit 131 is controlled by the WB control unit 121 to detect a face region of a person in the captured image from RGB data of the captured image. At this time, information not only on presence of a face but also on the size (total number of pixels) of the detected face region with respect to the entire image region is acquired. The face region detecting unit 131 supplies information of the detected face region to the eye region information acquiring unit 132 and the image processing unit 114.

In Step S243, the face region detecting unit 131 determines whether or not there is a face region in the captured image based on the acquired information which indicates the presence of a face region and the size of the face region. If it is determined in Step S243 that there is a face region, the processing proceeds to Step S244.

In Step S244, the eye region information acquiring unit 132 detects an eye region in the face region and determines whether or not there is an eye region. If it is determined in Step S244 that there is an eye region, the processing proceeds to Step S245. In Step S245, the eye region information acquiring unit 132 acquires pixel information of the detected eye region (eye region information) and supplies the pixel information of the acquired eye region to the high luminance region detecting unit 133.

In Step S246, the high luminance region detecting unit 133 detects a high luminance region with a high luminance than a predetermined luminance and determines whether or not there is a high luminance region. If it is determined in Step S246 that there is a high luminance region, the high luminance region detecting unit 133 supplies information of the detected high luminance region as pixel information of the light source part to the light source color estimating unit 141, and the processing proceeds to Step S247.

In Step S247, the white balance adjusting amount determining unit 123 and the image processing unit 114 perform face-localized WB processing. Since the face-localized WB processing is basically the same as the processing described above with reference to FIG. 9, the repeated description thereof will be omitted. As described above, the white balance of the face region is locally adjusted.

On the other hand, if it is determined in Step S241 that the white balance mode is not the face-localized WB mode, the processing proceeds to Step S248. In Step S248, it is determined whether or not the white balance mode at the time of imaging is the Automatic White Balance (AWB) mode. If it is determined in Step S248 that the white balance mode is the AWB mode, the processing proceeds to Step S249.

If it is determined in Step S243 that there is no face region, the processing proceeds to Step S249. For example, if there is no face region in the imaged scene, or if information indicates that the size of the face region with respect to the entire image region is smaller than a predetermined threshold value even when the face region is present, image information of an eye region which is necessary for performing the face-localized white balance processing is not effectively acquired, and therefore, it is determined that there is no face region.

If it is determined in Step S244 that there is no eye region, the processing proceeds to Step S249. Since effective pixel information is not obtained if an eye region is not sufficiently larger than a certain threshold value or it is found that a person is closing their eyes even if there is an eye region, it is determined that there is no eye region in Step S244.

If it is determined in Step S246 that there is no high luminance region, that is, there is no high luminance pixel with a luminance which exceeds a preset threshold value, it is determined that a light source has not been imaged, and the processing proceeds to Step S249.

In Step S249, the achromatic region detecting unit 134 and the white balance adjusting amount determining unit 123 perform normal white balance processing. Since the normal white balance processing is basically the same as the processing described above with reference to FIG. 11, the repeated description thereof will be omitted. As described above, the white balance of the entire captured image is corrected.

If it is determined in Step S248 that the white balance mode is not the AWB mode, the processing proceeds to Step S250. For example, if the user voluntarily selects white balance processing which has been preset for each light source or performs white balance processing for which the user inputs a color temperature of a light source, it is determined in Step S248 that the white balance mode is not the AWB mode, and the processing proceeds to Step S250.

In Step S250, the control unit 113 and the image processing unit 114 perform manual WB processing. That is, the control unit 113 supplies a white balance adjusting amount, which has been determined based on a user operation/selection input via the operation input unit 112, to the image processing unit 114. The image processing unit 114 adjusts the white balance of the entire image by using the white balance adjusting amount which has been determined based on the user operation/selection supplied from the control unit 113.

### Another Example of White Balance Processing

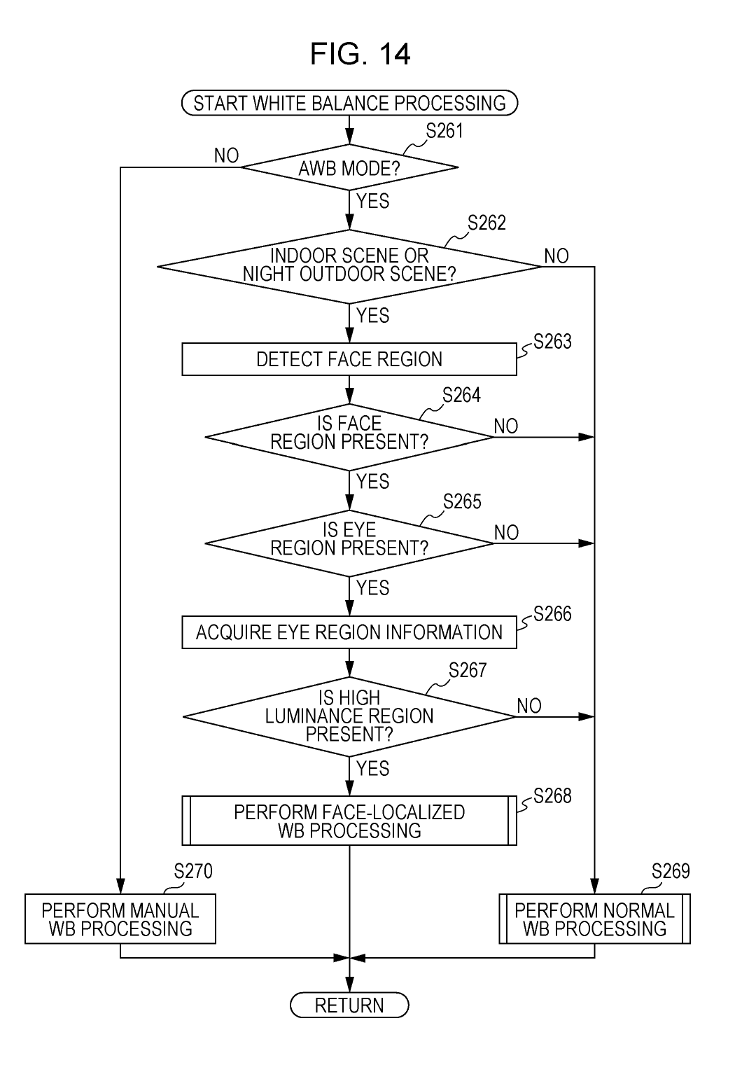

Next, a description will be given of the white balance processing in Step S112 in FIG. 7 with reference to the flowchart in FIG. 14.

In the example in FIG. 14, white balance processing in accordance with a brightness level of an imaged scene will be described. That is, a white balance adjusting amount which is appropriate for a person in foreground differs from a white balance adjusting amount which is appropriate for background when a night scene and a person are imaged without light emission or when a person is imaged in a spacious indoor environment. Various light sources are present together and a pixel region for effectively estimating the light sources is not sufficient in many cases especially in a case of a night scene, and there is a concern that color cast occurs in an image of a person by performing white balance processing on the entire frame with the same white balance adjusting amount.

Thus, a description will be given of a case where white balance processing is differently performed depending on whether or not a brightness level of an imaged scene corresponds to a brightness level in a case of an indoor environment or a night scene, as a method of performing the face-localized white balance processing according to the present technology in the example in FIG. 14.

In Step S261, the WB control unit 121 determines whether or not the white balance mode at the time of imaging is the Automatic White Balance (AWB) mode. If it is determined in Step S261 that the white balance mode is the AWB mode, that is, in a case of estimating a color temperature of a light source from the image and automatically performing white balance processing, the processing proceeds to Step S262.

In Step S262, the WB control unit 121 determines whether or not the imaged scene corresponds to an indoor environment/nighttime outdoor environment based on a brightness level of the image supplied from the image capturing unit 111. If it is determined in Step S262 that the scene corresponds to an indoor environment or a nighttime outdoor environment as a result of a comparison between the brightness level value of the image and a preset threshold value, the processing proceeds to Step S263.

In Step 263, the face region detecting unit 131 is controlled by the WB control unit 121 to detect a face region of a person in the captured image from RGB data of the captured image. At this time, information not only on presence of a face but also on a size (total number of pixels) of the detected face region with respect to the entire image region is acquired. The face region detecting unit 131 supplies information of the detected face region to the eye region information acquiring unit 132 and the image processing unit 114.

In Step S264, the face region detecting unit 131 determines whether or not there is a face region in the captured image based on the acquired information on the presence of a face region and the size of the face region. If it is determined in Step S264 that there is a face region, the processing proceeds to Step S265.

In Step S265, the eye region information acquiring unit 132 detects an eye region in the face region and determines whether or not there is an eye region. If it is determined in Step S265 that there is an eye region, the processing proceeds to Step S266, and the eye region information acquiring unit 132 acquires pixel information of the detected eye region (eye region information) and supplies pixel information of the acquired eye region to the high luminance region detecting unit 133.

In Step S267, the high luminance region detecting unit 133 detects a high luminance region with a higher luminance than a predetermined luminance and determines whether or not there is a high luminance region. If it is determined in Step S267 that there is a high luminance region, the high luminance region detecting unit 133 supplies information of the detected high luminance region as pixel information of the light source part to the light source color estimating unit 141, and the processing proceeds to Step S268.

In Step S268, the white balance adjusting amount determining unit 123 and the image processing unit 114 perform face-localized WB processing. The face-localized WB processing will be described later with reference to FIG. 9. As described above, the white balance of the face region is locally adjusted.

If it is determined in Step S262 that the brightness level is sufficiently high as in imaging in a daytime outdoor environment, it is determined that the imaged scene does not correspond to an indoor environment/night time outdoor environment, and the processing proceeds to Step S269.

If it is determined in Step S264 that there is no face region, the processing proceeds to Step S269. For example, if there is no face region in the imaged scene, or if information indicates that the size of the face region with respect to the entire image region is smaller than a predetermined threshold value even when the face region is present, image information of an eye region which is necessary for performing the face-localized white balance processing is not effectively acquired, and therefore, it is determined that there is no face region.

If it is determined in Step S265 that there is no eye region, the processing proceeds to Step S269. Since effective pixel information is not obtained if an eye region is not sufficiently larger than a certain threshold value or it is found that a person is closing eyes even there is an eye region, it is determined that there is no eye region in Step S265.

If it is determined in Step S267 that there is no high luminance region, that is, there is no high luminance pixel with a luminance which exceeds a preset threshold value, it is determined that a light source has not imaged, and the processing proceeds to Step S269.

In Step S269, the achromatic region detecting unit 134 and the white balance adjusting amount determining unit 123 perform normal white balance processing. Since the normal white balance processing is basically the same as the processing described above with reference to FIG. 11, the repeated description thereof will be omitted. As described above, the white balance of the entire captured image is corrected.

On the other hand, if it is determined in Step S261 that the white balance mode is not the AWB mode, the processing proceeds to Step S270. For example, if the user voluntarily selects white balance processing which has been preset for each light source or performs white balance processing for which the user inputs a color temperature of a light source, it is determined in Step S261 that the white balance mode is not the AWB mode, and the processing proceeds to Step S270.

In Step S270, the control unit 113 and the image processing unit 114 perform manual WB processing. That is, the control unit 113 supplies a white balance adjusting amount, which has been determined based on a user operation/selection input via the operation input unit 112, to the image processing unit 114. The image processing unit 114 adjusts the white balance of the entire image by using the white balance adjusting amount which has been determined based on the user operation/selection supplied form the control unit 113.

According to the present technology, it is possible to acquire a white balance adjusting amount, which is not affected by individual differences such as skin colors, eye colors, and the like, by using a light source which has been imaged in a region of an eye ball (high luminance region) as described above.

In addition, it is possible to more precisely estimate a light source color and perform white balance processing without employing a complicated method for estimating a light source color, by calculating a white balance adjusting amount (gain) with the use of information on a light source which has been imaged.

Furthermore, it is possible to optimally perform white balance control, respectively, even when a face and background are illuminated with different kinds of lighting, by locally performing the white balance control for the face region and for the other region in a separate manner.

The aforementioned series of processing can be executed by hardware and can be executed by software. When the series of processing is executed by software, a program which configures the software is installed in a computer. Here, the computer includes a computer which is embedded in dedicated hardware, a general-purpose personal computer capable of executing various functions by installing various programs, and the like.

### Configuration Example of Computer

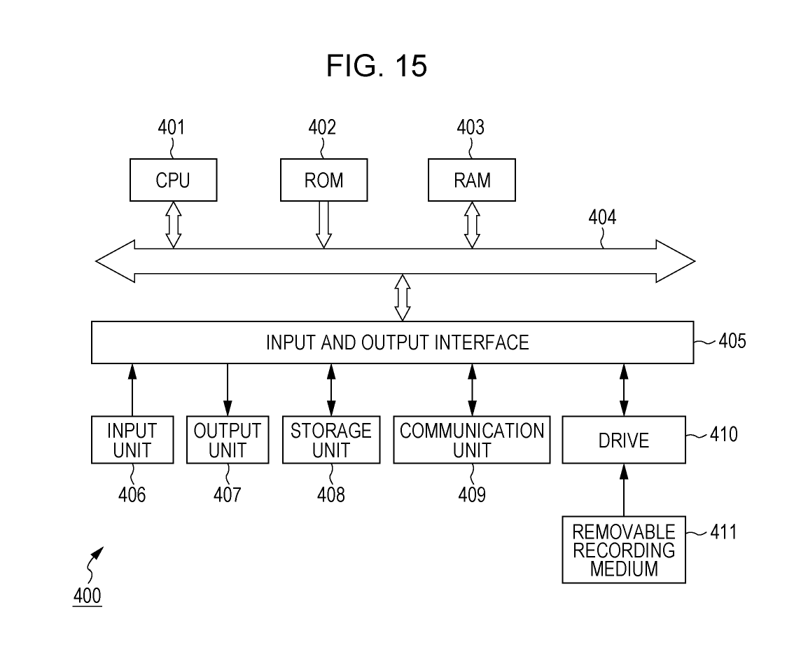

FIG. 15 shows a configuration example of hardware of a computer, which executes the aforementioned series of processing by a program.

In a computer 400, a Central Processing Unit (CPU) 401, a Read Only Memory (ROM) 402, and a Random Access Memory (RAM) 403 are connected to each other via a bus 404.

An input and output interface 405 is further connected to the bus 404. An input unit 406, an output unit 407, a storage unit 408, a communication unit 409, and a drive 410 are connected to the input and output interface 405.

The input unit 406 is configured by a keyboard, a mouse, a microphone, and the like. The output unit 407 is configured by a display, a speaker, and the like. The storage unit 408 is configured by a hard disk, a nonvolatile memory, and the like. The communication unit 409 is configured by a network interface and the like. The drive 410 drives a removable recording medium 411 such as a magnetic disk, an optical disc, a magnet-optical disc, or a semiconductor memory.

In the computer configured as described above, the aforementioned series of processing is performed by the CPU 401 loading a program stored on the storage unit 408, for example, to the RAM 403 via the input and output interface 405 and the bus 404 and executing the program.

The program executed by the computer (CPU 401) can be recorded in the removable recording medium 411 as a package medium or the like, for example, and be provided. In addition, the program can be provided via a wired or wireless transmission medium such as local area network, the Internet, and digital satellite broadcasting.

A computer can install the program in the storage unit 408 via the input and output interface 405 by mounting the removable recording medium 411 on the drive 410. In addition, the program can be installed in the storage unit 408 by receiving the program by the communication unit 409 via a wired or wireless transmission medium. In addition, the program can be installed in advance in the ROM 402 or the storage unit 408.

The program executed by a computer may be a program according to which the processing is performed in a time series manner in the order described in this specification or may be a program according to the processing which is performed in parallel or at a necessary timing such as a timing when the program is called.

Although it is a matter of course that the steps for describing the aforementioned series of processing includes processing which is performed in a time series manner in the order described herein, the steps are not necessarily performed in the time series manner, and the steps includes processing which is performed in parallel or in an individual manner in this specification.

In addition, embodiments of the present disclosure are not limited to the aforementioned embodiments, and various modifications can be made without departing from the gist of the present disclosure.

For example, the present technology can be configured as cloud computing in which a plurality of apparatuses share and cooperatively handle a function via network.

In addition, the respective steps described in the aforementioned flowcharts can be executed by one apparatus or shared and executed by a plurality of apparatuses.

Furthermore, when one step includes a plurality of processing procedures, the plurality of processing procedures included in the step can be executed by one apparatus or shared and executed by a plurality of apparatuses.

In addition, the configuration described above as an apparatus (or a processing unit) may be divided and configured as a plurality of apparatuses (or processing units). In an opposite manner, the configurations described above as a plurality of apparatuses (or processing units) may be collectively configured as one apparatus (or a processing unit). In addition, it is a matter of course that a configuration other than the configurations described above may be added to the configurations of the respective apparatuses (or the respective processing units). Furthermore, a part of a configuration of a certain apparatus (or a processing unit) may be included in a configuration of another apparatus (or another processing unit) as long as configurations and operations of the system are substantially the same. That is, the present technology is not limited to the aforementioned embodiments, and various modifications can be made without departing from the gist of the present technology.

Although preferable embodiments of the present disclosure were described above in detail with reference to the accompanying drawings, the present disclosure is not limited to such examples. It is obvious for those ordinarily skilled in the art that various modifications and amendments can be achieved within a technical idea disclosed in the claims, and it should be understood that such modifications and amendments also belong to a technical scope of the present disclosure.

In addition, the present technology can employ the following configurations:

(1) An image processing apparatus including: an eye region detecting unit which detects an eye region of an object in an image; a high luminance pixel detecting unit which detects a high luminance pixel with a higher luminance than a predetermined luminance based on pixels in the eye region detected by the eye region detecting unit; a light source color estimating unit which estimates information of a light source color from the high luminance pixel detected by the high luminance pixel detecting unit; a white balance adjusting amount calculating unit which calculates a white balance adjusting amount based on the information of the light source color estimated by the light source color estimating unit; and an image processing unit which adjusts a white balance of at least a partial region in the image by using the white balance adjusting amount calculated by the white balance adjusting amount calculating unit.

(2) The image processing apparatus according to (1), wherein the image processing unit adjusts the white balance of a face region of the object in the image, as at least partial region described above, by using the white balance adjusting amount which has been calculated by the white balance adjusting amount calculating unit.

(3) The image processing apparatus according to (1) or (2), wherein the image processing unit adjusts the white balance in a region other than the face region of the object in the image based on information of colors of the entire image.

(4) The image processing apparatus according to any one of (1) to (3), wherein the image processing unit adjusts the white balance of only the face region of the object in the image by using the white balance adjusting amount which has been calculated by the white balance adjusting amount calculating unit in accordance with a set imaging mode.

(5) The image processing apparatus according to any one of (1) to (3), wherein the image processing unit adjusts the white balance of only the face region of the object in the image by using the white balance adjusting amount which has been calculated by the white balance adjusting amount calculating unit in accordance with a brightness level of the image.

(6) The image processing apparatus according to (1), wherein the white balance adjusting amount calculating unit calculates the white balance adjusting amount based on the information of the colors of the entire image when the eye region detecting unit has not detected the eye region of the object or the high luminance pixel detecting unit has not detected the high luminance pixel.

(7) The image processing apparatus according to (1) or (6), wherein the white balance adjusting amount calculating unit calculates the white balance adjusting amount based on the information of the colors of the entire image when a size of the face region of the object in the image is smaller than a predetermined size.

(8) An image processing method performed by an image processing apparatus including: detecting an eye region of an object in an image; detecting a high luminance pixel with a higher luminance than a predetermined luminance based on pixels in the detected eye region; estimating information of a light source color from the detected high luminance pixel; calculating a white balance adjusting amount based on the information of the estimated light source color; and adjusting a white balance of at least a partial region of the image by using the calculated white balance adjusting amount.

(9) A program which causes an image processing apparatus to function as: an eye region detecting unit which detects an eye region of an object in an image; a high luminance pixel detecting unit which detects a high luminance pixel with a higher luminance than a predetermined luminance based on pixels in the eye region detected by the eye region detecting unit; a light source color estimating unit which estimates information of a light source color from the high luminance pixel detected by the high luminance pixel detecting unit; a white balance adjusting amount calculating unit which calculates a white balance adjusting amount based on the information of the light source color estimated by the light source color estimating unit; and an image processing unit which adjusts a white balance of at least a partial region in the image by using the white balance adjusting amount calculated by the white balance adjusting amount calculating unit.

The present disclosure contains subject matter related to that disclosed in Japanese Priority Patent Application JP 2012-198544 filed in the Japan Patent Office on Sep. 10, 2012, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
an eye region detecting unit which detects an eye region of an object in an image;
a high luminance pixel detecting unit which detects a high luminance pixel with a higher luminance than a predetermined luminance based on pixels in the eye region detected by the eye region detecting unit;
a light source color estimating unit which estimates information of a light source color from the high luminance pixel detected by the high luminance pixel detecting unit;
a white balance adjusting amount calculating unit which calculates a white balance adjusting amount based on the information of the light source color estimated by the light source color estimating unit; and
an image processing unit which adjusts a white balance of at least a partial region in the image by using the white balance adjusting amount calculated by the white balance adjusting amount calculating unit.

2. The image processing apparatus according to claim 1,
wherein the image processing unit adjusts the white balance of a face region of the object in the image, as the at least partial region, by using the white balance adjusting amount which has been calculated by the white balance adjusting amount calculating unit.

3. The image processing apparatus according to claim 2,
wherein the image processing unit adjusts the white balance in a region other than the face region of the object in the image based on information of colors of the entire image.

4. The image processing apparatus according to claim 2,
wherein the image processing unit adjusts the white balance of only the face region of the object in the image by using the white balance adjusting amount which has been calculated by the white balance adjusting amount calculating unit in accordance with a set imaging mode.

5. The image processing apparatus according to claim 2,
wherein the image processing unit adjusts the white balance of only the face region of the object in the image by using the white balance adjusting amount which has been calculated by the white balance adjusting amount calculating unit in accordance with a brightness level of the image.

6. The image processing apparatus according to claim 1,
wherein the white balance adjusting amount calculating unit calculates the white balance adjusting amount based on the information of the colors of the entire image when the eye region detecting unit has not detected the eye region of the object or the high luminance pixel detecting unit has not detected the high luminance pixel.

7. The image processing apparatus according to claim 1,
wherein the white balance adjusting amount calculating unit calculates the white balance adjusting amount based on the information of the colors of the entire image when a size of the face region of the object in the image is smaller than a predetermined size.

8. An image processing method performed by an image processing apparatus comprising:
detecting an eye region of an object in an image;
detecting a high luminance pixel with a higher luminance than a predetermined luminance based on pixels in the detected eye region;
estimating information of a light source color from the detected high luminance pixel;
calculating a white balance adjusting amount based on the information of the estimated light source color; and
adjusting a white balance of at least a partial region of the image by using the calculated white balance adjusting amount.

9. A program which causes an image processing apparatus to function as:
an eye region detecting unit which detects an eye region of an object in an image;
a high luminance pixel detecting unit which detects a high luminance pixel with a higher luminance than a predetermined luminance based on pixels in the eye region detected by the eye region detecting unit;
a light source color estimating unit which estimates information of a light source color from the high luminance pixel detected by the high luminance pixel detecting unit;
a white balance adjusting amount calculating unit which calculates a white balance adjusting amount based on the information of the light source color estimated by the light source color estimating unit; and
an image processing unit which adjusts a white balance of at least a partial region in the image by using the white balance adjusting amount calculated by the white balance adjusting amount calculating unit.
